(19) United States
(12) Patent Application Publication
(10) Pub. No.: US 2010/0135351 A1
(43) Pub. Date: Jun. 3, 2010

(54) Cooling Device for the Electrodes of a Metallurgical Furnace

(76) Inventors: Horst-Dieter Borgwardt, Dorsten (DE); Karl-Heinz Kummer, Duisburg (DE)

Correspondence Address: FRIEDRICH KUEFFNER, 317 MADISON AVENUE, SUITE 910, NEW YORK, NY, 10017, US

(21) Appl. No.: 11/990,156

(22) PCT Filed: Aug. 4, 2006
(86) PCT No.: PCT/EP2006/007761

§ 371 Date: Feb. 7, 2008

(30) Foreign Application Priority Data
Aug. 10, 2005 (DE) 20 2005 012 571.7

(51) Int. Cl. H05B 7/12

(52) U.S. Cl. 373/96

(57) ABSTRACT

A cooling device (4) for electrodes (1) of a metallurgical furnaces, such as reduction furnaces, arc furnaces, induction furnaces, etc. has at least one contact jaw (2) and a holding ring (3), and comprises a cooling shield or sealing cylinder (5) which ends in a frontal zone (9) comprising an outer ring (6), a front plate (7) and an inner ring (8), the frontal zone (9) being formed in a single piece.

The invention concerns a cooling device for the electrodes of a metallurgical furnace, such as a reduction furnace, arc furnace, induction furnace, etc., which encloses at least one clamp and one mounting ring and consists of a cooling shield/sealing cylinder, which ends in an end region that comprises an outer ring, an end plate, and an inner-ring,

DE 944 026 describes a low-set electrode holder for closed arc furnaces with a sealing cylinder that surrounds the holder, wherein the parts of the holder are installed in a cylinder that is open at the top, while the seal is located under the upper edge of the clamps, which extend out of the cylinder at the bottom.

DE 1 022 322 concerns a refinement of this device. It describes a low-set electrode holder for arc furnaces and reduction furnaces. This electrode holder has a sealing cylinder that surrounds the holder, extends into the furnace chamber, and is supported on the furnace roof, preferably in such a way that it can be vertically adjusted. The parts of the holder are installed in a cylinder that is open at the top, while the seal is located under the upper edge of the clamps, with the clamps being surrounded by an abutment that absorbs the reaction of the contact pressure against the electrodes.

Other designs of electrodes, electrode holders, mounting rings, clamps, etc., are described in DE 10 26 017, DE 14 40 358, DE 14 40 358, DE 23 12 099, DE 33 40 390 C2, DE 36 30 861 C2, and DE 43 42 511 C2.

DE 34 00 186 C2 discloses a feed-through structure for several electrodes through the roof of an arc furnace or reduction furnace, each with a double-walled, water-cooled hollow cylinder made of an electrically conducting material. The feed-through structure comprises an electrode and, when low-set electrode holders are used, the current feed-throughs that are arranged around the electrode parallel to its axis, and the clamps.

The low-set electrode holder for arc furnaces and reduction furnaces is described in DE 21 25 773 C3. In this regard, the power supply parts installed in the area of the furnace, especially current conductors, mounting parts, and the like, are protected by a double-walled, water-cooled cooling jacket that is arranged coaxially to the electrode. The cooling jacket extends as far as the cooled mounting ring and can be detached from it. The cooling jacket is divided into an upper cylindrical part and a lower cylindrical part by a plane that extends transversely to its axis. The lower part is divided into segmented cooling shields, which are detachably joined with one another and through which coolant flows.

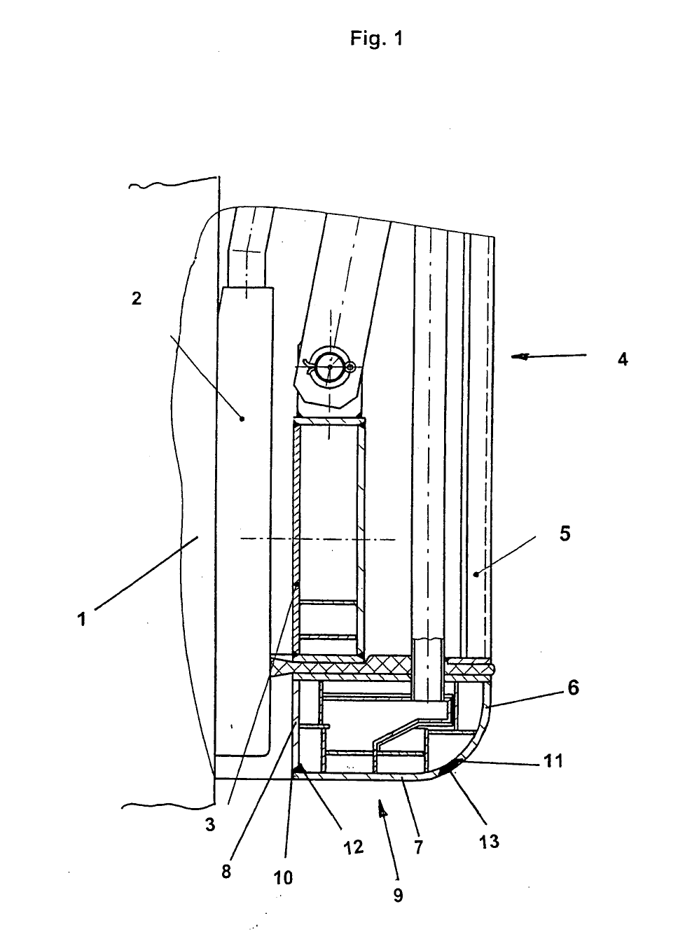

FIG. 1 shows a previously known design of a cooling device. The cooling device consists of several individual parts, which are joined together especially by welding. In this regard, the simplest possible shapes are considered for use as the individual parts. As the drawing shows, this known cooling device consists of an inner ring, which is welded at an angle with a ring-shaped end plate. The outer area of the end plate shows in cross section a radius that makes a transition into a cooling shield or sealing cylinder. The end region of the cooling shield or sealing cylinder consists of two parts, an inner ring and an end plate. In the end region, there are cavities for passing through a cooling medium, e.g., cooling water.

Temperature peaks in the furnace of up to about 2,000° C. produce high stresses in the areas of the welds, therefore the cooling device has a short life, especially in the end region. In addition, there is the danger that cooling water/cooling medium will escape from the cooling device and enter the furnace and lead to process disruptions that result in a shutdown of the whole plant.

The objective of the invention is to improve the previously known cooling device in a way that prevents the high stresses that produce especially the disadvantages described above. An improved design of the cooling device is intended to improve its reliability and service life.

In accordance with the invention, this objective is achieved by virtue of the fact that, in a cooling device of the type specified in the introductory clause of claim 1, the end region of the cooling device is constructed as a single part.

Further refinements of the cooling device are specified in the dependent claims.

The decisive advantage of the cooling device of the invention lies in the fact that the welds in the end region are shifted or eliminated. The special design of the end region of the cooling device results in a smaller surface of attack for blowers (heat).

The indicated improvements prevent or reduce furnace downtime and the reliability and service life of the mounted within the cooling device.

A specific embodiment of the invention and a prior-art device are described below with reference to the highly schematic drawings.

FIG. 1 shows a cutaway side view of a prior-art cooling device.

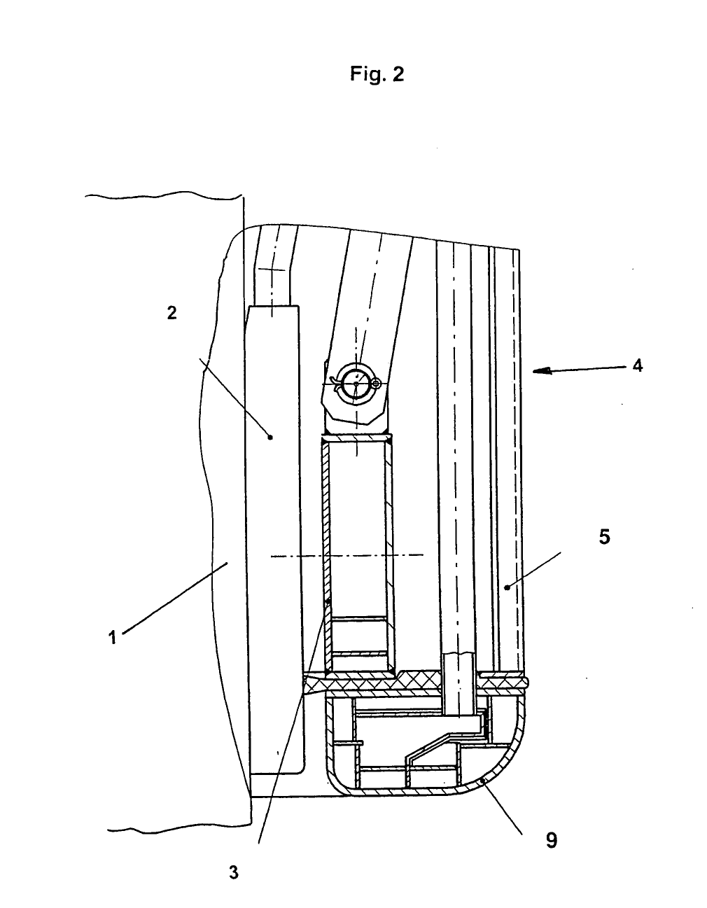

FIG. 2 shows a cutaway side view of a cooling device of the invention.

FIG. 1 shows a previously known design of an electrode 1 with an adjoining clamp 2 and a corresponding mounting ring 3. These individual parts/components are enclosed by a cooling device 4. The cooling device 4 consists of a cooling shield/sealing cylinder 5, which ends in its lower region in an outer ring 6. The outer ring 6, together with an end plate 7 and an inner ring 8, forms an end region 9, with the downwardly extending electrode 1 projecting beyond the end region 9 of the cooling device 4. The inner ring 8 and end plate 7 are welded together with a weld 12 in contact area 10, and the outer ring 6 and end plate 7 are welded together with a weld 13 in contact area 11.

FIG. 2 shows the cooling device 4 of the invention in a cutaway side view. The end region 9 is constructed as a single part in this case and has no weld. The cross-sectional shapes of the end region 9 can be designed in different ways according to the requirements and the material that is used.

### LIST OF REFERENCE NUMBERS

1 electrode

2 clamp

3 mounting ring

4 cooling device

5 cooling shield/sealing cylinder

6 outer ring

7 end plate

8 inner ring

9. end region

10 contact area

11 contact area

12 weld

13 weld

1. A cooling device (4) for the electrodes (1) of a metallurgical furnace, such as a reduction furnace, arc furnace, induction furnace, etc., which encloses at least one clamp (2) and one mounting ring (3) and consists of a cooling shield/sealing cylinder (5), whose end region (9) is formed by an outer ring (6), an end plate (7), and an inner ring (8), wherein the end region (9) is constructed as a single part, and the clamp (2) is designed to be mounted between the electrode (1) and the inner ring (8).

2. A cooling device (4) in accordance with claim 1, wherein the end region (9) is designed with a rectangular cross section.

3. A cooling device (4) in accordance with claim 1, wherein the end region (9) is designed with a trapezoidal cross section.

4. A cooling device (4) in accordance with claim 1, wherein the end region (9) is designed with a U-shaped cross section.

5. A cooling device (4) in accordance with claim 1, wherein the end region (9) consists of a highly heat-resistant material.
